(19) United States
(12) Patent Application Publication
(10) Pub. No.: US 2022/0138444 A1
(43) Pub. Date: May 5, 2022

(54) RADIO FREQUENCY IDENTIFICATION COMMUNICATION METHOD FOR COLLISION REDUCTION WITH LOW POWER CONSUMPTION AND RADIO FREQUENCY IDENTIFICATION COMMUNICATION SYSTEM USING THE SAME

(71) Applicant: Generalplus Technology Inc., Hsinchu City (TW)

(72) Inventors: Hsien-Yao LI, Hsinchu City (TW); Li Sheng LO, Hsinchu City (TW)

(21) Appl. No.: 17/105,133

(22) Filed: Nov. 25, 2020

(30) Foreign Application Priority Data
Nov. 2, 2020 (TW) 109138137

(51) Int. Cl. G06K 7/10; G06K 19/07

(52) U.S. Cl. CPC G06K 7/10029; G06K 19/0723; G06K 19/0705

(57) ABSTRACT

A radio frequency identification communication method for collision reduction with low power consumption and radio frequency identification communication system using the same are provided in the present invention. The radio frequency identification communication method includes the steps of: setting different delay periods according to different RFID tags; in each preset time, enabling a RFID reader and detecting whether a RFID tag is on the RFID reader; detecting whether there is only one RFID tag on the RFID reader; when two or more RFID tags on the RFID reader are detected in a specific time slot, entering a suspend mode to stop providing RF power such that the RFID tags perform power on reset when the reader is enabled next time.

This application claims priority of No. 109138137 filed in Taiwan R.O.C. on Nov. 2, 2020 under 35 USC 119, the entire content of which is hereby incorporated by reference.

### BACKGROUND OF THE INVENTION

### Field of the Invention

The invention relates to the radio frequency identification technology, and more particularly to a radio frequency identification communication method for collision reduction with low power consumption and a radio frequency identification communication system using the same.

### Description of the Related Art

RFID (Radio Frequency IDentification) is a wireless communication technology which uses a radio signal to identify a specific target and reading/writing the related data without mechanical or optical contact between the recognition system and a specific target. More and more industries have adopted RFID technology. For example, a tag on a car in production, the manufacturer can track the progress of the car on the production line by attaching a tag to a car in production. Moreover, the warehouse can track the location of medicines by RFID. Further, the RFID card allows employees to enter the locked room of the building, and the radio frequency transponder on the car can also be used to collect fee of toll road and parking lot.

However, those applications belong to the RFID reader using a non-battery power source. A general RFID reader would cause a communication collision when encountering too many RFID tags. Moreover, the anti-collision method of RFID is generally to give a random delay time so that the RFID tags are activated separately to avoid communication collisions again. When there are a small number of RFID tags, the information and quantity of the RFID tags can be quickly identified. But when there are more RFID tags, it takes a longer time to process the data of communication collisions, and it will also produce additional power consumption, which is a considerable burden on the RFID reader using the battery to serve as a power source.

### BRIEF SUMMARY OF THE INVENTION

An objective of the invention is to provide a radio frequency identification communication method for collision reduction with low power consumption and a radio frequency identification communication system using the same, which.

In view of this, the invention provides a radio frequency identification communication method, for identifying a plurality of RFID tags, wherein the radio frequency identification communication method includes: setting different active delay time according to the different ID of the plurality of RFID tags; enabling a RFID reader in each preset period and detecting whether there is a RFID tag or not; determining whether a collision is occurred when a tag is detected; and entering a standby mode when a collision is occurred and then recovering into a normal mode such that the RFID tags on a RFID reader performs power on reset.

The present invention further provides a radio frequency identification communication system. The radio frequency identification communication system includes a plurality of RFID tags and a RFID reader. Each RFID tags have different active delay time. The RFID reader is enabled after each preset period, and detects whether there is a RFID tag or not. The RFID reader determines whether a collision is occurred when a tag is detected; and when a collision is occurred, the RFID reader enters a standby mode and then enters a normal mode such that the RFID tags on a RFID reader performs power on reset.

The radio frequency identification communication method and the radio frequency identification communication system according to a preferred embodiment of the present invention, setting different active delay time according to the different ID of the plurality of RFID tags includes: dividing an energy output period of the RFID reader into N slot; and respectively setting N different active delay time for N different RFID tags, wherein the active delay time of K^{th} RFID tag is corresponding to K^{th} time slot, wherein N, K is a natural number, K is smaller than N, and K is greater than 0.

The radio frequency identification communication method and the radio frequency identification communication system according to a preferred embodiment of the present invention, each RFID tag comprises a resistor and a capacitor, wherein a corresponding active delay time is set according to charging/discharging time of the resistor and the capacitor. In another preferred embodiment of the present invention, each RFID tag comprises a real time clock (RTC), wherein a corresponding active delay time is set according to the setting of RTC.

The radio frequency identification communication method and the radio frequency identification communication system according to a preferred embodiment of the present invention, the radio frequency identification communication method further includes: being entered a sleep mode by RFID tags except for a preset transmission time after a corresponding active delay time such that power consumption can be reduced.

The spirit of the invention is to respectively preset the active delay time for each RFID tag. And when the collision occurs, the power is cut-off for every RFID tag on the RFID reader. After the RFID reader re-provides the RF power, the RFID tags restart and perform the active delay according to their different time slot. Thus, when a lot of RFID tag is placed on the RFID reader in the present invention, all of the RFIDs can be read in a short period. The probability of the communication collision is greatly reduced, and the power consumption is also greatly reduced.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

FIG. 1 illustrates a system block diagram of a RFID communication system according to a preferred embodiment of the present invention.

FIG. 2 illustrates a operational waveform of a RFID communication system according to a preferred embodiment of the present invention.

FIG. 3 illustrates a timing diagram of a RFID communication system when a collision is occurred according to a preferred embodiment of the present invention.

FIG. 4 illustrates a circuit diagram of a RFID tag 101 according to a preferred embodiment of the present invention.

FIG. 5A illustrates a circuit diagram of a RFID tag 101 according to a preferred embodiment of the present invention.

FIG. 5B illustrates a operational diagram of a RFID tag 101 according to a preferred embodiment of the present invention.

FIG. 6 illustrates a circuit diagram of a RFID tag 101 according to a preferred embodiment of the present invention.

FIG. 7 illustrates a flowchart of the radio frequency identification communication method according to a preferred embodiment of the present invention.

### DETAILED DESCRIPTION OF THE INVENTION

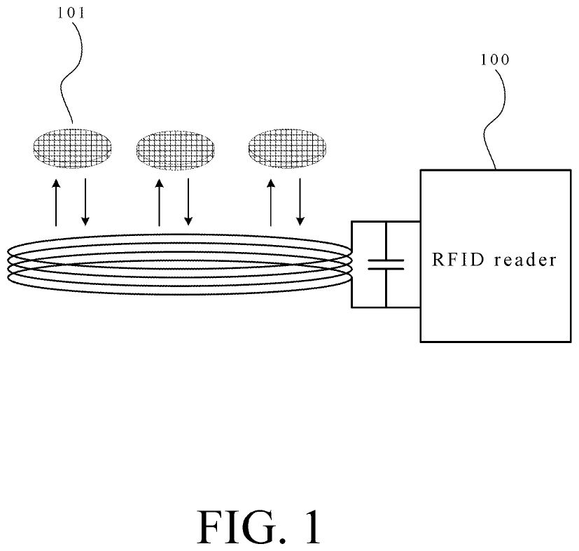

FIG. 1 illustrates a system block diagram of a RFID communication system according to a preferred embodiment of the present invention. Referring to FIG. 1, the RFID communication system includes a RFID reader 100 and a plurality of RFID tags 101. In this embodiment, the RFID reader 100 may use the battery to serve as its power source, such as a toy.

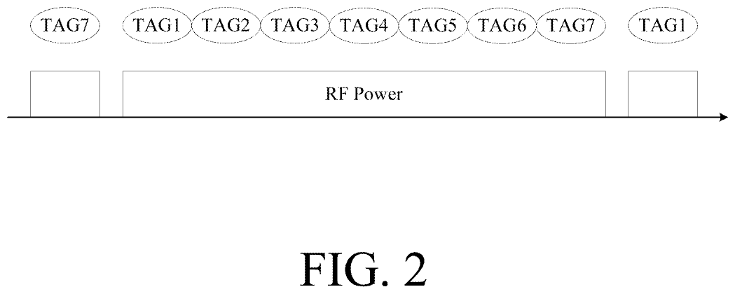

FIG. 2 illustrates a operational waveform of a RFID communication system according to a preferred embodiment of the present invention. Referring to FIG. 2, in this embodiment, it is assumed that there is 7 RFID tags (TAG1, TAG2 TAG7) in this RFID communication system. When the RFID reader 100 enters a normal mode from a sleep mode, the RFID reader 100 would provides an RF power from its coil, and the RFID tags on the coil, which receive the RF power, may not be active immediately. They are sequentially active according to their corresponding active delay time. For example, the RFID tag TAG1 would be active at time T1 after the RF power is provided, and the RFID tag TAG2 would be active at time T2 after the RF power is provided, and the RFID tag TAG3 would be active at time T3 after the RF power is provided, and so on.

In other words, the preferred embodiment divides the energy output period of the RFID reader into 7 time slots, and also, the RFID tags are individually set their active delay time, such that the RFID tag can be active in different time slot to perform communication with RFID reader in the energy output period (RF power providing period).

According to the abovementioned embodiment, each RFID tag TAG1˜TAG7 has its corresponding active delay time. Thus, when the RFID tags are put on the coil at the same time, the active delay time does not be overlapped. Thus, the communication collision would not be occurred. However, in the present invention, it may still occur a communication collision when RFID tags are put at different time point. The following embodiment would describe how to solve the communication collision in the present invention.

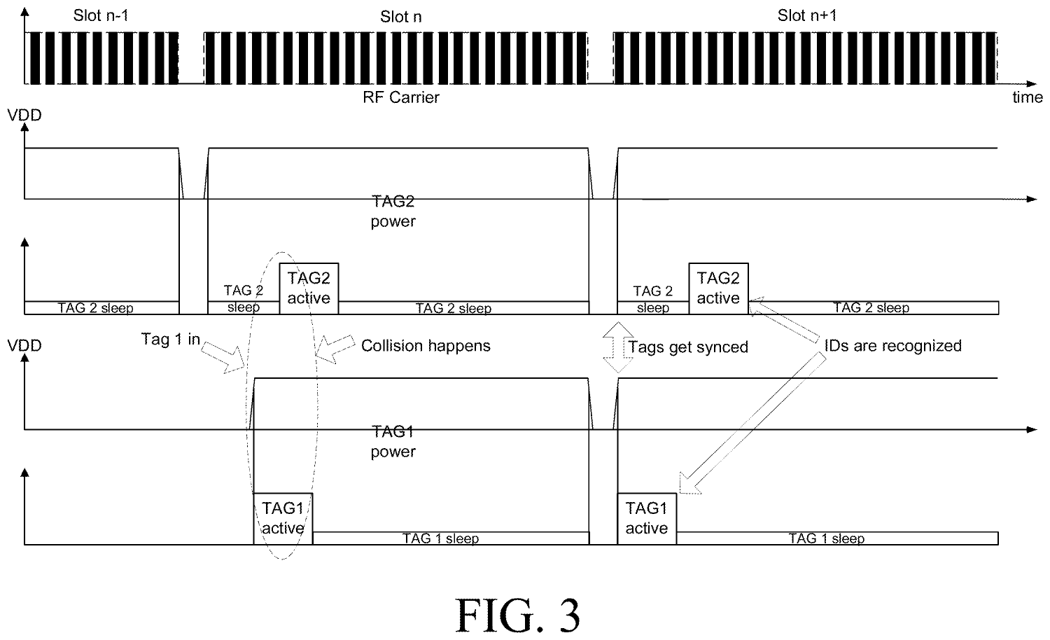

FIG. 3 illustrates a timing diagram of a RFID communication system when a collision is occurred according to a preferred embodiment of the present invention. Referring to FIG. 3, it is assumed that the RFID tag TAG2 is placed at the beginning, and the RFID tag TAG1 is placed in the time period when the RFID tag TAG2 are active. In this time, the RFID tag TAG1 is active and the RFID tag TAG2 is also active, and their active enable time are overlapped, and the communication collision occurs. At this time, the RFID reader 100 enters a standby mode, and shut down the RF power. When the RFID reader 100 restarts and re-provides the RF power, the RFID tag TAG1 and the RFID tag TAG2 would performs power on reset (POR) at the same time. Since the active delay time of the RFID tag TAG1 and the active delay time of the RFID tag TAG2 are preset and they are not overlapped, the first RFID TAG1 would be active and then the second RFID TAG2 would be active after POR. Thus, even if the collision occurs in the present invention, the collision would not occur at the next enabled time of the RFID reader. The RFID tags TAG1 and TAG2 are in the sleep mode except for their active periods. Since the RFID tags TAG1 and TAG2 are woken up at their specific time periods, the present invention can reduce a lot of power consumption.

In the abovementioned embodiment, the RFID tags are assigned their corresponding period to be active. The present invention not only can save power, but also greatly increases the number of RFID tags which the RFID reader 100 can read at the same time. In addition, each RFID tag in the abovementioned embodiment of the present invention would enters the sleep mode except for communication within a preset transmission time after the preset active delay time in order to save power.

In the prior art, it is assumed that the RFID tag need 0.4 mA when it is enabled, 7 RFID tags are placed on the RFID reader 100 would need 2.8 mA. That is, the RFID reader need to provide sufficient RF power to let the RFID tags acquire sufficient voltage to operate normally.

However, if the power control method in present invention is adopted, where the RFID tags are woken up at their specific time periods, and enters the sleep mode after the data transmission, until the RFID reader 100 re-provides RF power, and the RFID tags performs POR and re-synchronize their transmission and repeats those steps, the power consumption can be greatly reduced. As long as the RFID reader 100 can provides 0.4 mA in ideal, it can read all of the RFID tags on the coil.

Applicant conducts an experiment. Applicant tried to place as many RFID tags without using the present invention as possible to lot of RFID tags on the RFID reader, only 5 RFID tags placed on the RFID reader, the RFID reader cannot read. And Applicant tried to place as many RFID tags in the embodiment of the present invention as possible on the RFID reader, even 10, 15 RFID tags on the RFID reader, the RFID reader can successfully read their ID.

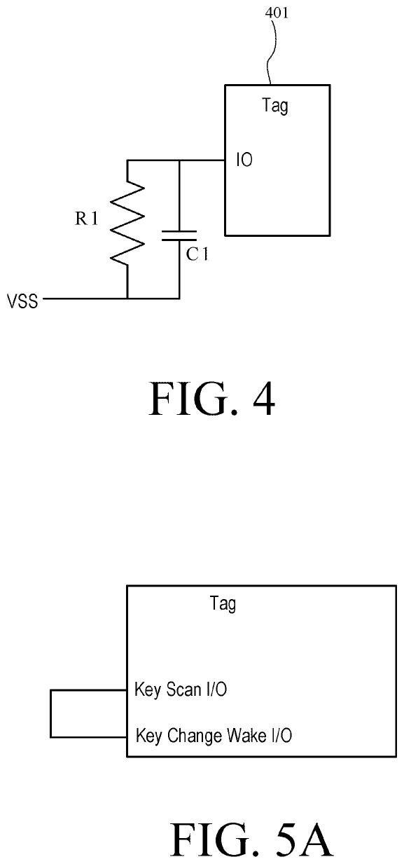

FIG. 4 illustrates a circuit diagram of a RFID tag 101 according to a preferred embodiment of the present invention. Referring to FIG. 4, in this embodiment, the RFID tag 101 includes a RFID tag IC 401, a resistor R1 and a capacitor C1. The resistor R1 and the capacitor C1 are coupled in parallel between the common voltage VSS and the input/output port IO of the RFID tag IC 401. In this embodiment, the active delay time of the RFID tag are set by the charging/discharging time of the resistor R1 and the capacitor C1. The advantage of this embodiment is the delay time can be controlled individually. The lack of this embodiment is the higher cost.

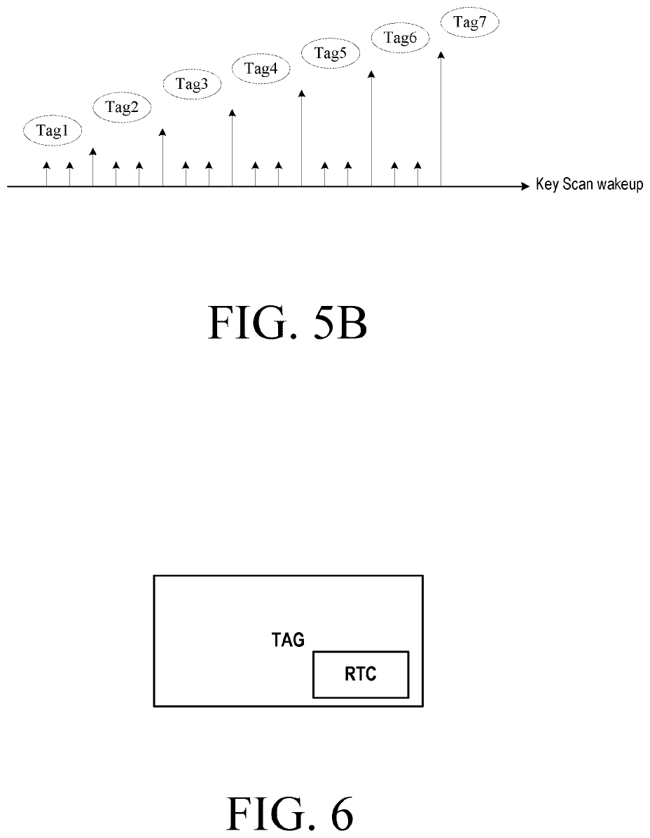

FIG. 5A illustrates a circuit diagram of a RFID tag 101 according to a preferred embodiment of the present invention. Referring to FIG. 5A, in this embodiment, the IC with key scan wake-up function is adopted. The IC is originally adopted for key scan wake-up. The I/O port of the key scan wake-up IC would provide a key scan pulse signal. The I/O port of the key scan wake-up IC is coupled to the wake-up I/O port. A data is transmitted according to the counts of the counter.

FIG. 5B illustrates a operational diagram of a RFID tag 101 according to a preferred embodiment of the present invention. Referring to FIG. 5B, for example, it is assumed that the transmission data of RFID tag need 17 ms (34*0.5 us), and the key scan pulse interval is 7.7 ms. When the RFID 2 performs data transmission, it should transmit the data after the third pulse. And so on and so forth, the RFID tag TAG7 should transmit data after the 18^{th} pulse.

FIG. 6 illustrates a circuit diagram of a RFID tag 101 according to a preferred embodiment of the present invention. Referring to FIG. 6, in this embodiment, the RFID tag with RTC (real time clock) circuit is adopted. By the RTC circuit, when the RFID enter the standby mode, the RTC starts timing. After counting to the preset time, the RFID tag is active and the data is transmitted.

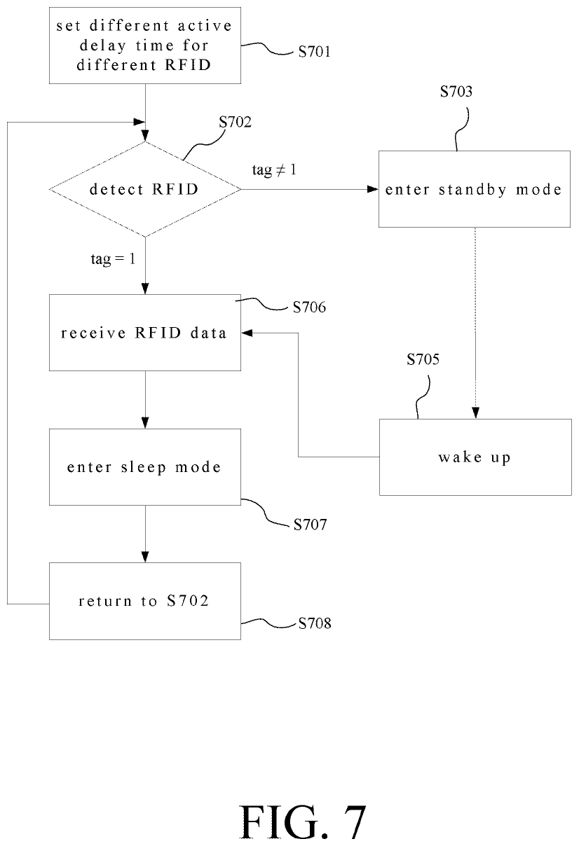

FIG. 7 illustrates a flowchart of the radio frequency identification communication method according to a preferred embodiment of the present invention. Referring to FIG. 7, the radio frequency identification communication method includes the steps of:

In step S701, the different active delay time for different RFID tags are set. For example, the abovementioned 7 RFID tags respectively have 7 different active delay times, that is, the 7 RFIDs respectively disposed in 7 time slot.

In step S702, the RFID tag is detected and whether the number of the RFID tag is 1 is determined. When it is determined the number of the RFID tag is 1, the step S706 is performed. When the number of the RFID is greater than 1, it means at least two ID are received at the same time, that is to say, the collision occurs, the step S703 is performed.

In step S703, when the number of the RFID is not 1, it represent that the communication collision occurs. At this time, the standby mode is entered. The RFID reader enters the standby mode, and stop to provide the RF power to the RFID tags.

In step S705, wake up. The RFID is woken up and provide the RF power. At this time, the RFID tags placed on the RFID reader 100 starts POR and they are active in their corresponding active delay time according their RFID codes.

In step S706, the RFID tag data is received.

In step S707, a sleep mode is entered.

In step S708, return to step S702.

In summary, the spirit of the invention is to respectively preset the active delay time for each RFID tag. And when the collision occurs, the power is cut-off for every RFID tag on the RFID reader. After the RFID reader re-provides the RF power, the RFID tags restart and perform the active delay according to their different time slot. Thus, when a lot of RFID tag is placed on the RFID reader in the present invention, all of the RFIDs can be read in a short period. The probability of the communication collision is greatly reduced, and the power consumption is also greatly reduced.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A radio frequency identification communication method, for identifying a plurality of RFID tags, wherein the radio frequency identification communication method comprises:
setting different active delay time according to the different ID of the plurality of RFID tags;
enabling a RFID reader in each preset period and detecting whether there is a RFID tag or not;
determining whether a collision is occurred when a tag is detected; and
entering a standby mode when a collision is occurred and then recovering into a normal mode such that the RFID tags on a RFID reader performs power on reset.

2. The radio frequency identification communication method according to claim 1, wherein setting different active delay time according to the different ID of the plurality of RFID tags comprises:
dividing an energy output period of the RFID reader into N slot; and
respectively setting N different active delay time for N different RFID tags, wherein the active delay time of K^{th} RFID tag is corresponding to K^{th} time slot,
wherein N, K is a natural number, K is smaller than N, and K is greater than 0.

3. The radio frequency identification communication method according to claim 2, wherein each RFID tag comprises a resistor and a capacitor, wherein a corresponding active delay time is set according to charging/discharging time of the resistor and the capacitor.

4. The radio frequency identification communication method according to claim 2, wherein each RFID tag comprises a real time clock (RTC), wherein a corresponding active delay time is set according to the setting of RTC.

5. The radio frequency identification communication method according to claim 1, further comprising:
being entered a sleep mode by RFID tags except for a preset transmission time after a corresponding active delay time such that a power consumption can be reduced.

6. A radio frequency identification communication system, comprising:
a plurality of RFID tags, wherein each RFID tags has different active delay time; and
a RFID reader, wherein the RFID reader is enabled after each preset period, and detects whether there is a RFID tag or not,
wherein the RFID reader determines whether a collision is occurred when a tag is detected; and when a collision is occurred, the RFID reader enters a standby mode and then enters a normal mode such that the RFID tags on a RFID reader performs power on reset.

7. The radio frequency identification communication system according to claim 6, wherein each RFID tags having different active delay time comprising:
dividing an energy output period of the RFID reader into N slot; and
respectively setting N different active delay time for N different RFID tags, wherein the active delay time of K^{th} RFID tag is corresponding to K^{th} time slot,
wherein N, K is a natural number, K is smaller than N, and K is greater than 0.

8. The radio frequency identification communication system according to claim 7, wherein each RFID tag comprises a resistor and a capacitor, wherein a corresponding active delay time is set according to charging/discharging time of the resistor and the capacitor.

9. The radio frequency identification communication system according to claim 7, wherein each RFID tag comprises a real time clock (RTC), wherein a corresponding active delay time is set according to the setting of RTC.

10. The radio frequency identification communication system according to claim 6, wherein the RFID tags enters a sleep mode except for a preset transmission time after a corresponding active delay time such that power consumption can be reduced.
